(19) United States
(12) Patent Application Publication
(10) Pub. No.: US 2026/0168471 A1
(43) Pub. Date: Jun. 18, 2026

(54) AIR FLOW RATE DETECTION DEVICE, AIR FLOW RATE DETECTION METHOD, AND STORAGE MEDIUM

(71) Applicant: HONDA MOTOR CO., LTD., TOKYO (JP)

(72) Inventors: Yoshiteru MIKI, TOKYO (JP); Ken MATSUI, TOKYO (JP); Katsuya SHIGENAGA, TOKYO (JP); Yoshiharu ISHIGAMI, TOKYO (JP); Takahaya FUJINAGA, TOKYO (JP)

(21) Appl. No.: 19/415,221

(22) Filed: Dec. 10, 2025

(30) Foreign Application Priority Data
Dec. 17, 2024 (JP) 2024-220974

(51) Int. Cl. F02M 35/10

(52) U.S. Cl. CPC F02M 35/10386

(57) ABSTRACT

An air flow rate detection device includes a signal acquisition unit that acquires sampling values output from an air flow meter provided in an intake pipe of an internal combustion engine, an air flow rate waveform acquisition unit that acquires an air flow rate waveform indicating an air flow rate in the intake pipe, based on detected air flow rates converted from the sampling values acquired by the signal acquisition unit, an approximate waveform calculation unit that calculates an approximate waveform that is a sine wave approximating a partial waveform that is a part of the air flow rate waveform, and an air flow rate calculation unit that calculates the air flow rate based on the approximate waveform.

### CROSS-REFERENCE TO RELATED APPLICATIONS

This application is based upon and claims the benefit of priority from Japanese Patent Application No. 2024-220974 filed on Dec. 17, 2024, the contents of which are incorporated herein by reference.

### BACKGROUND OF THE INVENTION

### Field of the Invention

The present disclosure relates to an air flow rate detection device, an air flow rate detection method, and a storage medium.

### Description of the Related Art

JP 2002-295292 A discloses a fuel injection control device. In thermal flow sensors, different errors occur in the forward and reverse directions during a pulsating flow. The fuel injection control device can measure the average flow rate of such a pulsating flow including the reverse flow with high accuracy by adding the difference between the errors in the forward and reverse directions to the reverse direction table value.

### SUMMARY OF THE INVENTION

Conventionally, efforts have been made for the purpose of climate change mitigation or impact reduction, and research and development on exhaust gas purification devices have been conducted to achieve the purpose.

In the field of the exhaust gas purification devices, there is a demand for improved air flow rate detection devices, improved air flow rate detection methods, programs for causing a computer to execute such improved air flow rate detection methods, and storage medium storing such programs for causing a computer to execute such improved air flow rate detection methods. In order to solve the above problems, an object of the present disclosure is to provide a more favorable air flow rate detection device, a more favorable air flow rate detection method, a program for causing a computer to execute the more favorable air flow rate detection method, and a storage medium storing the program for causing the computer to execute the more favorable air flow rate detection method. Thus, this contributes to climate change mitigation or impact reduction.

A first aspect of the present disclosure is an air flow rate detection device including: a signal acquisition unit that acquires sampling values output from an air flow meter provided in an intake pipe of an internal combustion engine; an air flow rate waveform acquisition unit that acquires an air flow rate waveform indicating an air flow rate in the intake pipe, based on detected air flow rates converted from the sampling values acquired by the signal acquisition unit; an approximate waveform calculation unit that calculates an approximate waveform that is a sine wave approximating a partial waveform that is a part of the air flow rate waveform; and an air flow rate calculation unit that calculates the air flow rate based on the approximate waveform.

A second aspect of the present disclosure is an air flow rate detection method including: a signal acquisition step of, with a signal acquisition unit, acquiring sampling values output from an air flow meter provided in an intake pipe of an internal combustion engine; an air flow rate waveform acquisition step of, with an air flow rate waveform acquisition unit, acquiring an air flow rate waveform indicating an air flow rate in the intake pipe, based on detected air flow rates converted from the sampling values acquired by the signal acquisition unit; an approximate waveform calculation step of, with an approximate waveform calculation unit, calculating an approximate waveform that is a sine wave approximating a partial waveform that is a part of the air flow rate waveform; and an air flow rate calculation step of, with an air flow rate calculation unit, calculating the air flow rate based on the approximate waveform.

A third aspect of the present disclosure is a program that causes a computer to execute the air flow rate detection method according to the second aspect.

A fourth aspect of the present disclosure is a non-transitory computer-readable storage medium storing the program according to the third aspect.

According to the present disclosure, it is possible to provide a more favorable air flow rate detection device, a more favorable air flow rate detection method, a program for causing a computer to execute the more favorable air flow rate detection method, and a storage medium storing the program for causing the computer to execute the more favorable air flow rate detection method.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a block diagram showing a configuration of an air flow rate detection device according to an embodiment of the present disclosure;

FIG. 2 is a diagram illustrating a method of calculating an air flow rate in an embodiment of the present disclosure;

FIG. 3 is a graph showing a relationship between an actual air flow rate and a sampling value detected by an air flow meter in an embodiment of the present disclosure;

FIG. 4 is a diagram showing an air flow rate waveform and an approximate waveform in an embodiment of the present disclosure;

FIG. 5 is a diagram illustrating a method of acquiring an air flow rate waveform in an embodiment of the present disclosure;

FIG. 6 is a diagram illustrating a method of determining a local maximum point in an embodiment of the present disclosure;

FIG. 7 is a diagram illustrating a method of determining a local maximum point in an embodiment of the present disclosure;

FIG. 8 is a diagram illustrating a method of determining a local maximum point in an embodiment of the present disclosure; and

FIG. 9 is a flowchart showing a flowchart of a processing in air flow rate calculation control in an embodiment of the present disclosure.

### DETAILED DESCRIPTION OF THE INVENTION

In order to improve the combustion efficiency of fuel, in gasoline vehicles, the fuel injection amount is determined according to the air flow rate in the intake pipe of the internal combustion engine such that the weight ratio of air and fuel in the air-fuel mixture supplied to the internal combustion engine becomes a theoretical air-fuel ratio (stoichiometric ratio, λ=1) or a predetermined air-fuel ratio. Therefore, it is necessary to obtain the air flow rate with high accuracy by the air flow rate detection device.

The intake pipe of an internal combustion engine is equipped with an air flow meter. The air flow meter outputs a sampling value. The magnitude of the sampling value changes according to the air flow rate in the intake pipe. The sampling value is converted into an air flow rate. Hereinafter, the air flow rate obtained by conversion of the sampling value may be referred to as a detected air flow rate.

Each cylinder of the internal combustion engine takes in air intermittently by opening and closing the intake valve, which generates a pulsating flow in the intake pipe. Therefore, when the detected air flow rates are arranged in the order in which the sampling values were obtained, a waveform close to a sine wave can be obtained. This waveform shows a time variation of the air flow rate in the intake pipe. The waveform indicating the time variation in the air flow rate in the intake pipe obtained based on the sampling value will be hereinafter referred to as an air flow rate waveform.

The air flow rate detection device calculates, as the air flow rate, an average of the detected air flow rates indicated by a plurality of points on the air flow rate waveform of one cycle.

However, due to the structure of the air flow meter, the sensitivity of the air flow meter to the air flow rate is relatively low in a case where the actual air flow rate in the intake pipe is relatively low, and in particular, the downward convex portion in the air flow rate waveform may be greatly disturbed. The accuracy of the air flow rate calculated based on such a disturbed air flow rate waveform is relatively low, and an appropriate fuel injection amount cannot be determined for the actual air flow rate. As a result, the combustion efficiency of fuel is lowered, so that the fuel efficiency is deteriorated disadvantageously.

According to the present disclosure, it is possible to suppress a decrease in the accuracy of the air flow rate calculated in a case where the air flow rate is relatively low.

A control device for an internal combustion engine, a control method for an internal combustion engine, a program, and a storage medium according to an embodiment will be described below with reference to the drawings.

A program (computer program, computer software) according to an embodiment may also be referred to as a computer program product. The computer program product is not limited to a computer program stored in a storage medium, and includes a computer program transmitted, distributed, or downloaded via the Internet or the like.

### Embodiment

### [Configuration of Air Flow Rate Detection Device]

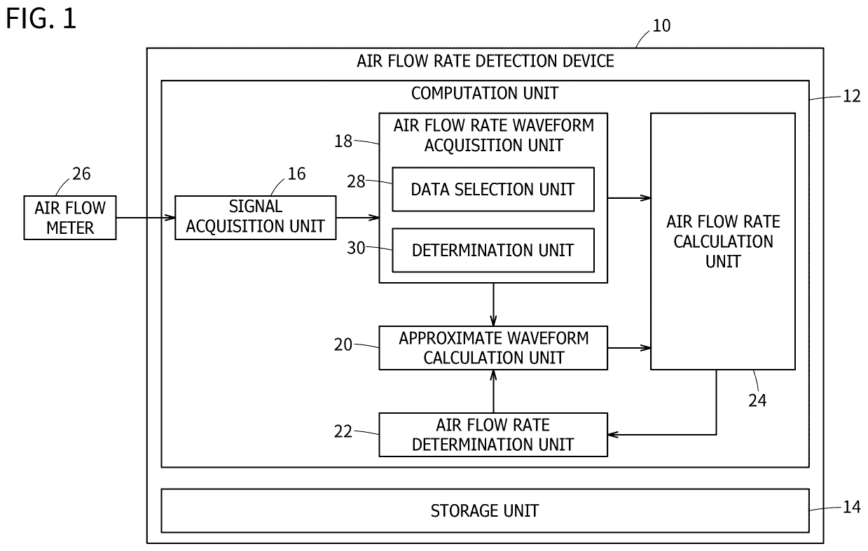

FIG. 1 is a block diagram showing a configuration of an air flow rate detection device 10 according to an embodiment of the present disclosure. The air flow rate detection device 10 detects a flow rate of air flowing through an intake pipe of an internal combustion engine.

The air flow rate detection device 10 includes a computation unit 12 and a storage unit 14. The computation unit 12 is, for example, a processor such as a central processing unit (CPU), a graphics processing unit (GPU), or the like. The computation unit 12 includes a signal acquisition unit 16, an air flow rate waveform acquisition unit 18, an approximate waveform calculation unit 20, an air flow rate determination unit 22, and an air flow rate calculation unit 24. The signal acquisition unit 16, the air flow rate waveform acquisition unit 18, the approximate waveform calculation unit 20, the air flow rate determination unit 22, and the air flow rate calculation unit 24 are realized by the computation unit 12 executing a program stored in the storage unit 14. At least part of the signal acquisition unit 16, the air flow rate waveform acquisition unit 18, the approximate waveform calculation unit 20, the air flow rate determination unit 22, and the air flow rate calculation unit 24 may be realized by an integrated circuit such as an application specific integrated circuit (ASIC), a field-programmable gate array (FPGA), or the like. At least part of the signal acquisition unit 16, the air flow rate waveform acquisition unit 18, the approximate waveform calculation unit 20, the air flow rate determination unit 22, and the air flow rate calculation unit 24 may be realized by an electronic circuit including a discrete device.

The storage unit 14 is a computer-readable non-transitory tangible storage medium. The storage unit 14 includes a volatile memory (not illustrated) and a non-volatile memory (not illustrated). The volatile memory is, for example, a random access memory (RAM) or the like. The non-volatile memory is, for example, a read only memory (ROM), a flash memory, or the like. Data and the like are stored in, for example, the volatile memory. Programs, tables, maps, and the like are stored, for example, in the nonvolatile memory. At least a part of the storage unit 14 may be included in the processor, the integrated circuit, or the like as described above. At least a part of the storage unit 14 may be mounted on a device connected to the air flow rate detection device 10 via a network.

The signal acquisition unit 16 acquires a sampling value output from an air flow meter 26. The air flow meter 26 is provided in an intake pipe of the internal combustion engine. The sampling value output from the air flow meter 26 depends on the air flow rate in the intake pipe. The air flow meter 26 includes a sensing element. The sensing element is provided with a temperature-sensitive resistance element, and the temperature-sensitive resistance element is heated to a constant temperature by a heater. The resistance of the temperature-sensitive resistance element changes when the temperature-sensitive resistance element is exposed to the flowing air, and the voltage output by the sensing element changes accordingly. Since the voltage change increases as the air flow rate increases, the voltage output from the sensing element can be converted into the air flow rate.

When the air flow meter 26 is an analog type, the voltage output from the sensing element is output as a sampling value as it is. When the air flow meter 26 is a digital type, a frequency obtained by digitally converting a voltage output from the sensing element is output as a sampling value. In one embodiment, an example using the digital air flow meter 26 is shown, but the analog air flow meter 26 may be used. The detected air flow rate obtained by conversion of the voltage or the frequency in the air flow meter 26 may be output from the air flow meter 26.

The air flow rate waveform acquisition unit 18 acquires an air flow rate waveform based on the sampling values sequentially acquired by the signal acquisition unit 16. The air flow rate waveform acquisition unit 18 further includes a data selection unit 28 and a determination unit 30. The data selection unit 28 and the determination unit 30 will be described in detail later. The approximate waveform calculation unit 20 calculates an approximate waveform that approximates a partial waveform that is a part of the air flow rate waveform. The air flow rate determination unit 22 determines whether or not the air flow rate calculated by the air flow rate calculation unit 24 described later is equal to or higher than a predetermined flow rate. The air flow rate calculation unit 24 calculates the air flow rate based on the air flow rate waveform or the approximate waveform.

### [Method of Calculating Air Flow Rate]

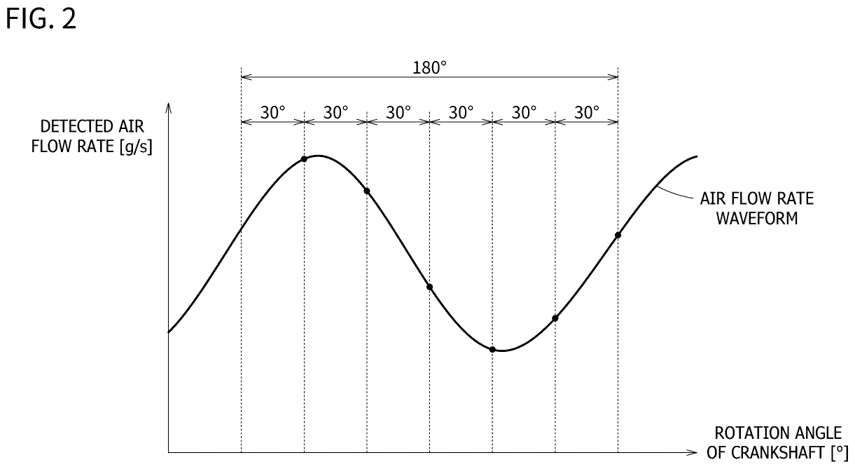

FIG. 2 is a diagram illustrating a method of calculating an air flow rate in an embodiment of the present disclosure. The graph of FIG. 2 shows a relationship between the detected air flow rate and the rotation angle of the crankshaft, of a four-cylinder internal combustion engine.

Each time the crankshaft of the internal combustion engine rotates twice (720 degrees), each cylinder undergoes an intake stroke, a compression stroke, an expansion stroke (power stroke), and an exhaust stroke. In the case where the internal combustion engine is a four-cylinder gasoline engine, when the crankshaft rotates 180 degrees, the intake stroke is performed in a first cylinder, the compression stroke is performed in a second cylinder, the expansion stroke is performed in a third cylinder, and the exhaust stroke is performed in a fourth cylinder. Therefore, as shown in FIG. 2, the air flow rate waveform is a waveform close to a sine wave having a wavelength of 180 degrees. The wavelength of the air flow rate waveform in a three-cylinder internal combustion engine or the wavelength of the air flow rate waveform in a six-cylinder internal combustion engine is different from the wavelength of the air flow rate waveform in the four-cylinder internal combustion engine.

The air flow rate calculation unit 24 calculates, as the air flow rate, the average of the detected air flow rates indicated by six points on the air flow rate waveform at intervals of 30 degrees of the rotation angle of the crankshaft.

### [Method of Acquiring Air Flow Rate and Method of Calculating Approximate Waveform]

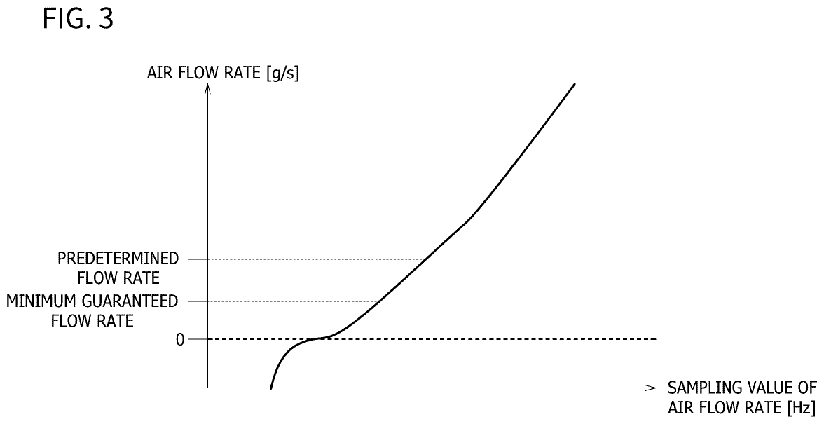

FIG. 3 is a graph showing a relationship between an actual air flow rate and a sampling value output from the air flow meter 26 in the embodiment.

As described above, the sensitivity of the air flow meter 26 to the air flow rate is relatively low in a region where the air flow rate is relatively low, due to the structure of the air flow meter 26. As shown in FIG. 3, in a region where the air flow rate is higher than a minimum guaranteed flow rate, the relationship between the actual air flow rate and the sampling value changes linearly. On the other hand, in a region where the air flow rate is equal to or lower than the minimum guaranteed flow rate, the relationship between the actual air flow rate and the sampling value changes nonlinearly. The minimum guaranteed flow rate is a minimum value of the air flow rate at which the detection accuracy of the air flow meter 26 can be guaranteed. The minimum guaranteed flow rate is set based on the detection performance, the detection characteristics, and the like of the air flow meter 26.

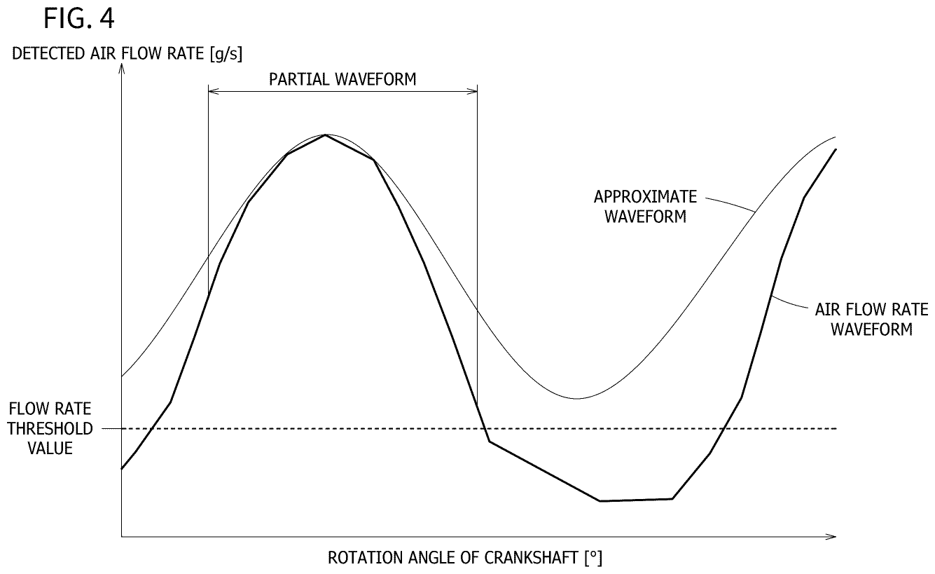

FIG. 4 is a diagram showing an air flow rate waveform and an approximate waveform in an embodiment of the present disclosure. The air flow rate waveform shown in FIG. 4 is a waveform calculated based on the detected air flow rates converted from the sampling values acquired in a case where the actual air flow rate in the intake pipe is relatively low. In the air flow rate waveform shown in FIG. 4, in particular, a downward convex portion, which is a portion of the air flow rate waveform on the region where the detected air flow rate is low, is greatly distorted. The air flow rate cannot be obtained with high accuracy from the distorted air flow rate waveform as shown in FIG. 4.

Therefore, in the region where the air flow rate is relatively low, the air flow rate calculation unit 24 calculates the air flow rate based on the approximate waveform. The approximate waveform is a sine wave that approximates a partial waveform that is a part of the air flow rate waveform. The partial waveform at least includes an upward convex portion which is a portion of the air flow rate waveform on the region where the detected air flow rate is high. The partial waveform excludes a portion of the air flow rate waveform that is equal to or less than a predetermined flow rate threshold value. In other words, the partial waveform at least includes a portion of the air flow rate waveform that is greater than the flow rate threshold value. The flow rate threshold value indicates a value of the minimum guaranteed flow rate described above. The flow rate threshold value may be different from the value of the minimum guaranteed flow rate.

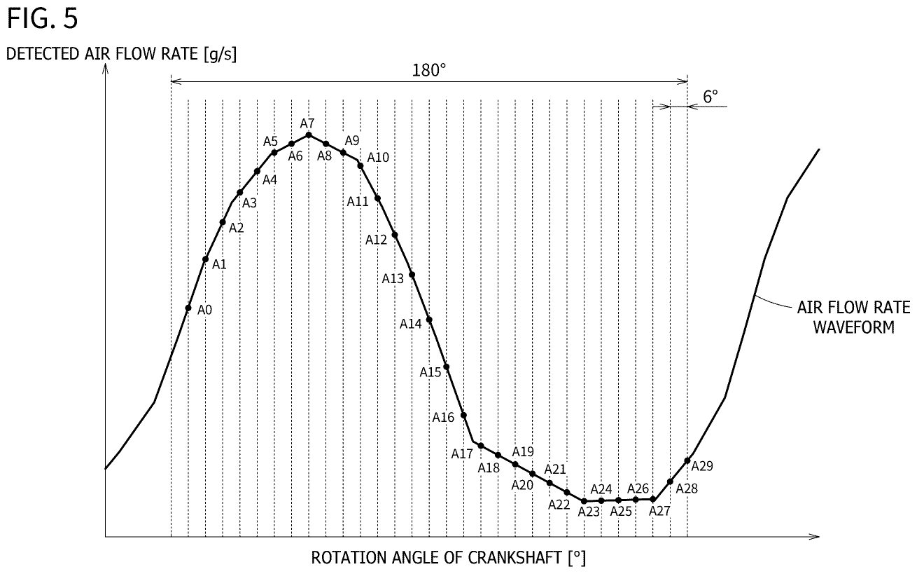

Hereinafter, a method of acquiring the air flow rate waveform will be described. FIG. 5 is a diagram illustrating the method of acquiring the air flow rate waveform in an embodiment of the present disclosure.

The signal acquisition unit 16 acquires a sampling value from the air flow meter 26, for example, at intervals of 6 degrees in terms of the rotation angle of the crankshaft. The timing at which the signal acquisition unit 16 acquires the sampling value may not be every 6 degrees of the rotation angle of the crankshaft. The signal acquisition unit 16 may also acquire the sampling value from the air flow meter 26 at predetermined time intervals.

The air flow rate waveform acquisition unit 18 acquires an air flow rate waveform by storing, as elements of an array A, the detected air flow rates converted from the sampling values sequentially acquired by the signal acquisition unit 16, in the array A in a sequential manner. The number of the elements of the array A is, for example, 30, and the array A is composed of elements A0 to A29. The air flow rate waveform is formed of a detected air flow rate sequence (a sequence of detected air flow rates) including 30 detected air flow rates corresponding to the sampling values sequentially acquired by the signal acquisition unit 16. The detected air flow rate sequence including the 30 detected air flow rates indicates an air flow rate waveform corresponding to an angular interval of 180 degrees in the rotation angle of the crankshaft. The number of the detected air flow rates constituting the detected air flow rate sequence may be different from 30.

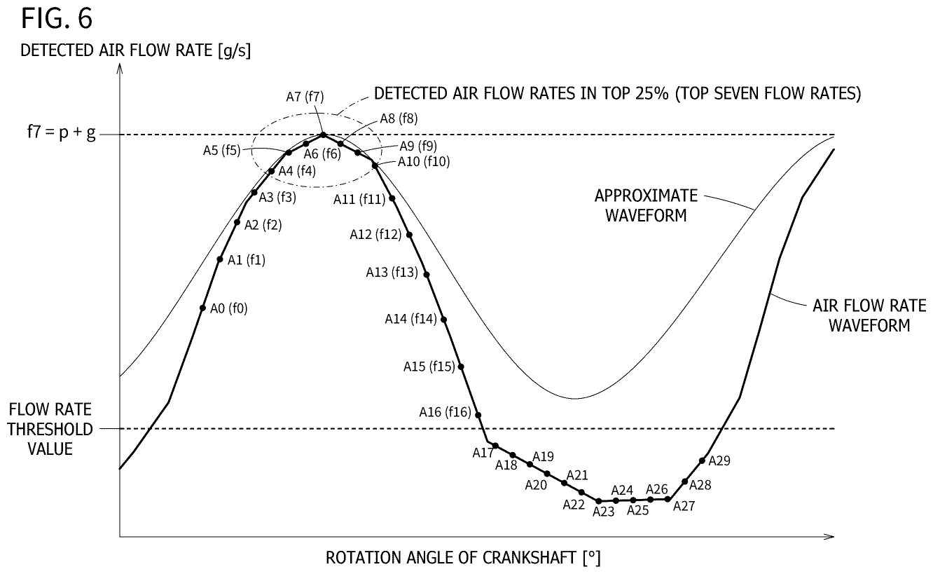

Further, the air flow rate waveform acquisition unit 18 determines a local maximum point of the air flow rate waveform. FIG. 6 is a diagram illustrating a method of determining the local maximum point in an embodiment of the present disclosure. The description “A0 (f0)” in FIG. 6 indicates that the detected air flow rate stored in the element A0 is “f0”, for example.

First, the data selection unit 28 of the air flow rate waveform acquisition unit 18 selects, from the detected air flow rate sequence, a plurality of detected air flow rates whose magnitudes are in a top predetermined percentage of the detected air flow rate sequence. In a case where the detected air flow rate sequence is constituted by 30 detected air flow rates and the top predetermined percentage is 25%, the top seven detected air flow rates are selected. In the example shown in FIG. 6, the detected air flow rates of the elements A4 to A10 of the sequence A are selected.

Next, the determination unit 30 of the air flow rate waveform acquisition unit 18 determines the local maximum point of the air flow rate waveform based on the plurality of detected air flow rates selected by the data selection unit 28. The determination unit 30 determines the local maximum point based on the detected air flow rates corresponding to an intermediate time point between the earliest time point and the latest time point among the acquisition time points corresponding to the plurality of detected air flow rates selected by the data selection unit 28.

In the example shown in FIG. 6, the detected air flow rate corresponding to the earliest time point is the detected air flow rate of the element A4. The detected air flow rate corresponding to the latest time point is the detected air flow rate of the element A10. The detected air flow rate corresponding to the intermediate time point between the earliest time point and the latest time point is the detected air flow rate of the element A7 positioned at the center among the detected air flow rates of the selected elements A4 to A10. That is, the element A7 is selected as the local maximum point of the air flow rate waveform, and the detected air flow rate f7 of the element A7 becomes the local maximum value of the air flow rate waveform.

In the example shown in FIG. 6, the number of the selected detection air flow rates is an odd number, but may be an even number. For example, when the data selection unit 28 selects eight detected air flow rates of the elements A4 to A11 in the sequence A, a point between the elements A7 and A8 may be determined as the local maximum point. In this case, the average of the detected air flow rate f7 of the element A7 and the detected air flow rate f8 of the element A8 may be set as the local maximum value of the air flow rate waveform.

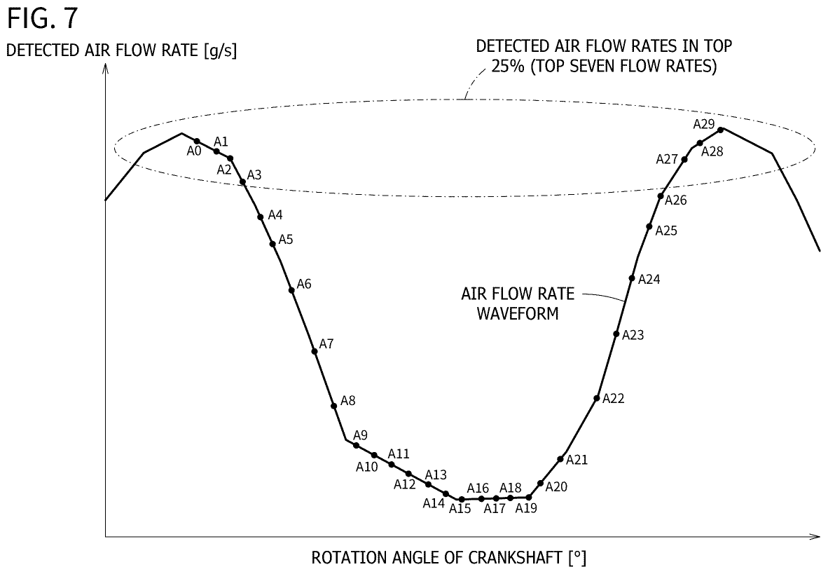

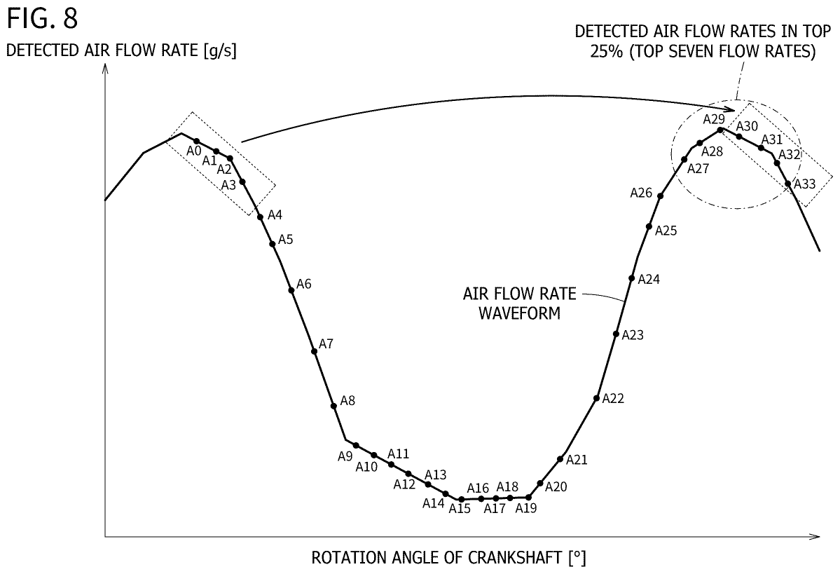

FIGS. 7 and 8 are diagrams illustrating a method of determining a local maximum point in an embodiment. As shown in FIG. 7, there are cases where the head portion and the tail portion of the detected air flow rate sequence may be selected by the data selection unit 28. In the example shown in FIG. 7, the elements A0 to A3 (the head portion) and the elements A27 to A29 (the tail portion) of the sequence A, which is a sequence of the detected air flow rates, are selected by the data selection unit 28.

In this case, the determination unit 30 may determine the local maximum point based on the plurality of detected air flow rates rearranged by disposing the head portion after the tail portion. In the example illustrated in FIG. 8, the elements A0 to A3 (the head portion) of the sequence A are rearranged into the elements A30 to A33 that are subsequent to the elements A27 to A29 (the tail portion). The determination unit 30 determines the local maximum value based on the air flow rate data values of the elements A27 to A33.

Hereinafter, a method of calculating the approximate waveform will be described with reference to FIG. 6. The approximate waveform is a sine wave approximating a partial waveform which is a part of the air flow rate waveform. In the example shown in FIG. 6, the portions corresponding to the elements A0 to A16 of the sequence A forms a partial waveform.

Variables p and q, and the detected air flow rates of the elements A0 to A16 are used to set up Equations (1) to (17) as follows.

f7=p+q (1)

f6=p sin(π/2−π/15)+q (2)

f5=p sin(π/2−2π/15)+q (3)

f4=p sin(π/2−3π/15)+q (4)

f3=p sin(π/2−4π/15)+q (5)

f2=p sin(π/2−5π/15)+q (6)

f1=p sin(π/2−6π/15)+q (7)

f0=p sin(π/2−7π/15)+q (8)

f8=p sin(π/2+π/15)+q (9)

f9=p sin(π/2+2π/15)+q (10)

f10=p sin(π/2+3π/15)+q (11)

f11=p sin(π/2+4π/15)+q (12)

f12=p sin(π/2+5π/15)+q (13)

f13=p sin(π/2+6π/15)+q (14)

f14=p sin(π/2+7π/15)+q (15)

f15=p sin(π/2+8π/15)+q (16)

f16=p sin(π/2+9π/15)+q (17)

When solving for “p” by eliminating “q” using Equations (2) to (17) and Equation (1), Equations (18) to (33) are obtained as follows.

P=(f7−f6)/{1−sin(π/2−π/15)} (18)

P=(f7−f5)/{1−sin(π/2−2π/15)} (19)

P=(f7−f4)/{1−sin(π/2−3π/15)} (20)

P=(f7−f3)/{1−sin(π/2−4π/15)} (21)

P=(f7−f2)/{1−sin(π/2−5π/15)} (22)

P=(f7−f1)/{1−sin(π/2−6π/15)} (23)

P=(f7−f0)/{1−sin(π/2−7π/15)} (24)

P=(f7−f8)/{1−sin(π/2+π/15)} (25)

P=(f7−f9)/{1−sin(π/2+2π/15)} (26)

P=(f7−f10)/{1−sin(π/2+3π/15)} (27)

P=(f7−f11)/{1−sin(π/2+4π/15)} (28)

P=(f7−f12)/{1−sin(π/2+5π/15)} (29)

P=(f7−f13)/{1−sin(π/2+6π/15)} (30)

P=(f7−f14)/{1−sin(π/2+7π/15)} (31)

P=(f7−f15)/{1−sin(π/2+8π/15)} (32)

P=(f7−f16)/{1−sin(π/2+9π/15)} (33)

The average of the variables p obtained from Equations (18) to (33) is defined as the amplitude P of the approximate expression. The center Q of oscillation in the approximate expression is obtained from the following Equation (34).

Q=f7−P (34)

The approximate waveform is expressed by Equation (35) using the amplitude P and the center Q of oscillation obtained as described above. In Equation (35), “F” represents an approximate value of the air flow rate indicated by the approximate waveform, “θ” represents the rotation angle of the crankshaft, and “θ7” represents the rotation angle of the crankshaft corresponding to the detected air flow rate f7 of the element A7.

F=A sin {2(θ+θ7−π/4)}+Q (35)

In one embodiment, the element A7 is selected as the local maximum point of the air flow rate waveform. Therefore, in Equation (35), the phase of the approximate waveform is defined by using the rotation angle θ7 of the crankshaft corresponding to the detected air flow rate f7 of the element A7. For example, in a case where the point between the element A7 and the element A8 is selected as the local maximum point of the air flow rate waveform, the phase of the approximate waveform may be defined by using the center value (θ7+θ8)/2 of the rotation angle θ7 of the crankshaft corresponding to the detected air flow rate f7 of the element A7 and the rotation angle θ8 of the crankshaft corresponding to the detected air flow rate f8 of the element A8.

When the air flow rate determination unit 22 determines that the air flow rate is equal to or higher than the predetermined flow rate, the air flow rate calculation unit 24 calculates, as the air flow rate, an average of the detected air flow rates indicated by the six points on the air flow rate waveform at angular intervals of 30 degrees in terms of the rotation angle of the crankshaft. When the air flow rate determination unit 22 determines that the air flow rate is lower than the predetermined flow rate, the air flow rate calculation unit 24 calculates, as the air flow rate, an average of the air flow rate approximate values indicated by the six points on the approximate waveform at angular intervals of 30 degrees in terms of the rotation angle of the crankshaft.

### [Air Flow Rate Calculation Control]

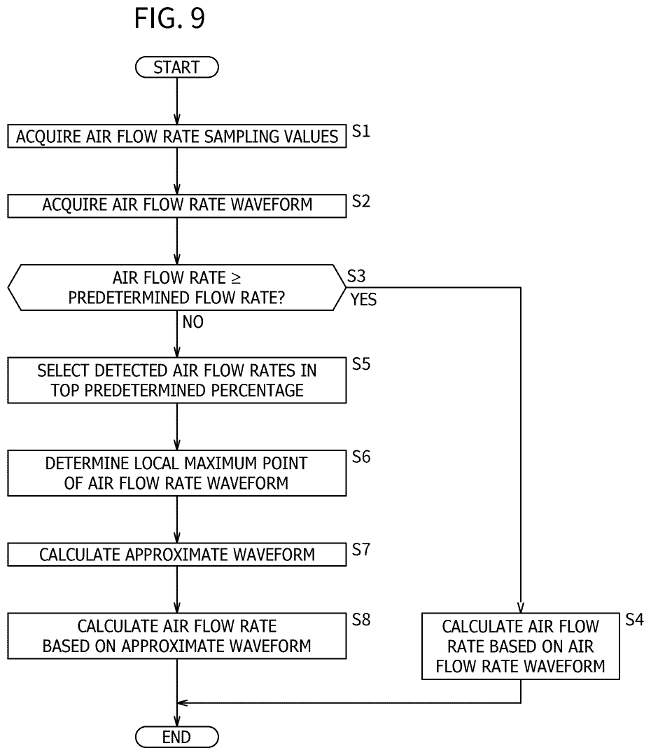

FIG. 9 is a flowchart showing a processing in air flow rate calculation control according to an embodiment of the present disclosure. The air flow rate calculation control is repeatedly executed at a predetermined period.

In step S1, the signal acquisition unit 16 acquires sampling values output from the air flow meter 26. Thereafter, the process proceeds to step S2.

In step S2, the air flow rate waveform acquisition unit 18 acquires an air flow rate waveform based on the detected air flow rates converted from the sampling values sequentially acquired by the signal acquisition unit 16. Thereafter, the process proceeds to step S3.

In step S3, the air flow rate determination unit 22 determines whether or not the air flow rate calculated by the air flow rate calculation unit 24 is equal to or higher than a predetermined flow rate. The air flow rate determination unit 22 performs the determination based on the air flow rate calculated by the air flow rate calculation unit 24 at the time of the previous air flow rate calculation control.

When the air flow rate calculated by the air flow rate calculation unit 24 is equal to or higher than the predetermined flow rate (step S3: YES), the process proceeds to step S4. In step S4, the air flow rate calculation unit 24 calculates the air flow rate based on the air flow rate waveform. Thereafter, the air flow rate calculation control is terminated.

When the air flow rate calculated by the air flow rate calculation unit 24 is lower than the predetermined flow rate (step S3: NO), the process proceeds to step S5. In step S5, the data selection unit 28 of the air flow rate waveform acquisition unit 18 selects, from the detected air flow rate sequence, a plurality of air flow rate data points whose magnitudes of detected air flow rate are in a top predetermined percentage of the detected air flow rate sequence. Thereafter, the process proceeds to step S6.

In step S6, the determination unit 30 of the air flow rate waveform acquisition unit 18 determines the local maximum point of the air flow rate waveform based on the plurality of detected air flow rates selected by the data selection unit 28. Thereafter, the process proceeds to step S7.

In step S7, an approximate waveform approximating a partial waveform which is a part of the air flow rate waveform is calculated. Thereafter, the process proceeds to step S8.

In step S8, the air flow rate calculation unit 24 calculates the air flow rate based on the approximate waveform. Thereafter, the air flow rate calculation control is terminated.

### Operation and Effects

In the present disclosure, in the case where the air flow rate calculated by the air flow rate calculation unit 24 is lower than the predetermined flow rate, the air flow rate calculation unit 24 calculates the air flow rate based on the approximate waveform. The approximate waveform is a sine wave that approximates a partial waveform that is a part of the air flow rate waveform.

This makes it possible to suppress a decrease in the accuracy of the air flow rate calculated by the air flow rate calculation unit 24 in the case where the air flow rate in the intake pipe is relatively low.

The following Supplementary Notes are further disclosed in relation to the above embodiment.

### (Supplementary Note 1)

The air flow rate detection device (10) according to the present disclosure includes the signal acquisition unit (16) that acquires sampling values output from the air flow meter (26) provided in the intake pipe of the internal combustion engine, the air flow rate waveform acquisition unit (18) that acquires the air flow rate waveform indicating the air flow rate in the intake pipe, based on the detected air flow rates converted from the sampling values acquired by the signal acquisition unit, the approximate waveform calculation unit (20) that calculates the approximate waveform that is a sine wave approximating a partial waveform that is a part of the air flow rate waveform, and the air flow rate calculation unit (24) that calculates the air flow rate based on the approximate waveform. Thus, in the case where the air flow rate in the intake pipe is relatively low, it is possible to suppress a decrease in the accuracy of the air flow rate calculated by the air flow rate calculation unit.

### (Supplementary Note 2)

The air flow rate detection device according to Supplementary Note 1 may further include the air flow rate determination unit (22) configured to determine whether or not the air flow rate is equal to or higher than the predetermined flow rate, wherein in the case where the air flow rate determination unit determines that the air flow rate is equal to or higher than the predetermined flow rate, the air flow rate calculation unit may calculate the air flow rate based on the air flow rate waveform, and in the case where the air flow rate determination unit determines that the air flow rate is lower than the predetermined flow rate, the air flow rate calculation unit may calculate the air flow rate based on the approximate waveform.

### (Supplementary Note 3)

In the air flow rate detection device according to Supplementary Note 1, the partial waveform may at least include an upward convex portion which is a portion of the air flow rate waveform in which the air flow rate is high.

### (Supplementary Note 4)

In the air flow rate detection device according to Supplementary Note 3, the partial waveform may exclude a portion, of the air flow rate waveform, whose air flow rate is equal to or less than the predetermined flow rate threshold value.

### (Supplementary Note 5)

In the air flow rate detection device according to Supplementary Note 3 or 4, the air flow rate waveform may be formed of a detected air flow rate sequence formed of a plurality of the detected air flow rates corresponding to the sampling values acquired by the signal acquisition unit, the air flow rate waveform acquisition unit may include: the data selection unit (28) configured to select, from among the detected air flow rate sequence, a plurality of detected air flow rates whose magnitudes are in the top predetermined percentage of the detected air flow rate sequence; and the determination unit (30) configured to determine the local maximum point of the air flow rate waveform based on the plurality of detected air flow rates selected by the data selection unit, and the approximate waveform calculation unit may calculate the approximate waveform using the local maximum point determined by the determination unit.

### (Supplementary Note 6)

In the air flow rate detection device according to Supplementary Note 5, the determination unit may determine the local maximum point based on the detected air flow rate corresponding to the intermediate time point between the earliest time point and the latest time point among the acquisition time points corresponding to the plurality of detected air flow rates selected by the data selection unit.

### (Supplementary Note 7)

In the air flow rate detection device according to Supplementary Note 5, in the case where the head portion and the tail portion of the detected air flow rate sequence are selected by the data selection unit, the determination unit may determine the local maximum point based on the plurality of detected air flow rates rearranged by disposing the head portion after the tail portion.

### (Supplementary Note 8)

The air flow rate detection method according to the present disclosure includes: the signal acquisition step of, with the signal acquisition unit, acquiring sampling values output from the air flow meter provided in the intake pipe of the internal combustion engine; the air flow rate waveform acquisition step of, with the air flow rate waveform acquisition unit, acquiring the air flow rate waveform indicating the air flow rate in the intake pipe, based on the detected air flow rates converted from the sampling values acquired by the signal acquisition unit; the approximate waveform calculation step of, with the approximate waveform calculation unit, calculating the approximate waveform that is a sine wave approximating a partial waveform that is a part of the air flow rate waveform; and the air flow rate calculation step of, with the air flow rate calculation unit, calculating the air flow rate based on the approximate waveform.

### (Supplementary Note 9)

A program according to the present disclosure causes a computer to execute the air flow rate detection method according to Supplementary Note 8.

### (Supplementary Note 10)

A non-transitory computer-readable storage medium according to the present disclosure stores the program according to Supplementary Note 9.

Although the present disclosure has been described in detail, the present disclosure is not necessarily limited to each of the aforementioned embodiments. In these embodiments, various addition, replacement, changing, partial deletion, and the like can be made without departing from the essence and gist of the present disclosure or without departing from the essence and gist of the present disclosure derived from the contents described in the claims and equivalents thereof. These embodiments may also be implemented in combination. For example, in the above-described embodiments, the order of operations and the order of processes are shown as examples, and the present invention is not limited to them. The same applies to a case where numerical values or mathematical equations are used in the description of the above-described embodiments.

1. An air flow rate detection device comprising one or more processors that execute computer-executable instructions stored in a memory, wherein the one or more processors execute the computer-executable instructions to cause the air flow rate detection device to:
acquire sampling values output from an air flow meter provided in an intake pipe of an internal combustion engine;
acquire an air flow rate waveform indicating an air flow rate in the intake pipe, based on detected air flow rates converted from the sampling values that have been acquired;
calculate an approximate waveform that is a sine wave approximating a partial waveform that is a part of the air flow rate waveform; and
calculate the air flow rate based on the approximate waveform.

2. The air flow rate detection device according to claim 1, wherein the one or more processors cause the air flow rate detection device further to:
determine whether or not the air flow rate is equal to or higher than a predetermined flow rate;
calculate the air flow rate based on the air flow rate waveform in a case where it is determined that the air flow rate is equal to or higher than the predetermined flow rate; and
calculate the air flow rate based on the approximate waveform in a case where it is determined that the air flow rate is lower than the predetermined flow rate.

3. The air flow rate detection device according to claim 1, wherein
the partial waveform at least includes an upward convex portion which is a portion of the air flow rate waveform in which the air flow rate is high.

4. The air flow rate detection device according to claim 3, wherein
the partial waveform excludes a portion, of the air flow rate waveform, whose air flow rate is equal to or less than a predetermined flow rate threshold value.

5. The air flow rate detection device according to claim 3, wherein:
the air flow rate waveform is formed of a detected air flow rate sequence including a plurality of the detected air flow rates corresponding to the sampling values that have been acquired; and
the one or more processors cause the air flow rate detection device further to:
select, from among the detected air flow rate sequence, a plurality of detected air flow rates whose magnitudes are in a top predetermined percentage of the detected air flow rate sequence;
determine a local maximum point of the air flow rate waveform based on the plurality of detected air flow rates that have been selected; and
calculate the approximate waveform using the local maximum point that has been determined.

6. The air flow rate detection device according to claim 5, wherein
the local maximum point is determined based on the detected air flow rate corresponding to an intermediate time point between an earliest time point and a latest time point among acquisition time points corresponding to the plurality of detected air flow rates that have been selected.

7. The air flow rate detection device according to claim 5, wherein
in a case where a head portion and a tail portion of the detected air flow rate sequence are selected, the local maximum point is determined based on the plurality of detected air flow rates rearranged by disposing the head portion after the tail portion.

8. An air flow rate detection method executed by one or more processors, the method comprising:
acquiring sampling values output from an air flow meter provided in an intake pipe of an internal combustion engine;
acquiring an air flow rate waveform indicating an air flow rate in the intake pipe, based on detected air flow rates converted from the sampling values that have been acquired;
calculating an approximate waveform that is a sine wave approximating a partial waveform that is a part of the air flow rate waveform; and
calculating the air flow rate based on the approximate waveform.

9. A non-transitory computer-readable storage medium storing a program for causing a computer to execute the air flow rate detection method according to claim 8.
